(19) United States
(12) Patent Application Publication
(10) Pub. No.: US 2024/0290311 A1
(43) Pub. Date: Aug. 29, 2024

(54) KEYBOARD DEVICE

(71) Applicant: KAWAI MUSICAL INSTRUMENTS MANUFACTURING CO., LTD., Hamamatsu-shi (JP)

(72) Inventors: Akihiro SUZUKI, Hamamatsu-shi (JP); Yoshiaki SHIMODA, Hamamatsu-shi (JP)

(21) Appl. No.: 18/584,196

(22) Filed: Feb. 22, 2024

(30) Foreign Application Priority Data
Feb. 27, 2023 (JP) 2023-028594
Mar. 1, 2023 (JP) 2023-031062

(51) Int. Cl. G10H 1/34

(52) U.S. Cl. CPC G10H 1/346; G10H 2220/221; G10H 2220/265

(57) ABSTRACT

A keyboard device is provided. The keyboard device includes a keyboard in which keys are provided so as to be each pivotally movable, a hammer configured to be pivotally moved at key-pressing, and a keyboard chassis that supports the keyboard and the hammer. The hammer includes a weight on its rear-end side. Each key includes a key body, a fixing part, and a connection part that connects a rear end of the key body and the fixing part to each other. The connection part has a structure bent so as to protrude upward and contains, on a lower inside of the connection part, a space where the weight on the rear-end side of the hammer is allowed to enter at key-pressing.

### CROSS-REFERENCE TO RELATED APPLICATIONS

This application claims the benefits of Japanese Patent Application No. 2023-028594 filed on Feb. 27, 2023 with the Japan Patent Office and Japanese Patent Application No. 2023-031062 filed on Mar. 1, 2023 with the Japan Patent Office, the entire disclosures of which are incorporated herein by reference.

### BACKGROUND

The present disclosure relates to a keyboard device that can be used in a keyboard instrument, such as an electronic piano.

For example, Japanese Unexamined Patent Application Publication No. 2022-047578 discloses a keyboard instrument including a keyboard device, and the keyboard device includes a keyboard and a keyboard chassis that supports the keyboard. This keyboard instrument is configured such that hammers are arranged under corresponding keys of the keyboard and such that, when a front-end part of each hammer is pressed by an actuator of the corresponding key at key-pressing, the hammer is moved pivotally and a rear-end part thereof is raised accordingly.

For this kind of keyboard instrument, a configuration is known in which a weight (i.e., a hammer weight) is attached to a rear end of the hammer and the weight is made to protrude significantly toward a rear-end side of the keyboard chassis, in order to obtain an appropriate weight of the key at key-pressing (i.e., key-touch weight). That is, the keyboard instrument is designed to increase a moment of a force by attaching the weight to the rear end of the hammer so as to protrude rearward.

Alternatively, Japanese Unexamined Patent Application Publication No. 2022-132683 discloses a structure in which the height of the keyboard device is increased (i.e., its vertical dimension is increased) and in which the hammer is arranged so as to extend in a lower part of the keyboard device and a large-sized weight is attached to a rear part of the hammer.

### SUMMARY

However, in the above-described technique disclosed in Japanese Unexamined Patent Application Publication No. 2022-047578, the dimension of the keyboard device in a front-rear direction needs to be large as the weight on the rear end of the hammer protrudes significantly toward the rear-end side of the keyboard chassis to ensure an appropriate key-touch weight. This has led to a problem that the keyboard device (and thus the keyboard instrument) is difficult to make compact.

Moreover, in the above-described technique disclosed in Japanese Unexamined Patent Application Publication No. 2022-132683, since the height of the keyboard device is increased to arrange the hammer with the large-sized weight in the lower part of the keyboard device, there has been a similar problem that the keyboard device (and thus the keyboard instrument) is difficult to make compact.

One aspect of the present disclosure is to provide a technique that enables a keyboard device to be made compact while ensuring an appropriate key-touch weight.

(1) One aspect of the present disclosure is a keyboard device comprising a keyboard in which keys are provided so as to be each pivotally movable, a hammer configured to be pivotally moved by being pressed by each key at key-pressing, and a keyboard chassis that supports the keyboard and the hammer.

In this keyboard device, the hammer includes a weight on its rear-end side. Each key includes a key body extending in a front-rear direction, a fixing part fixed to the keyboard chassis, and a connection part that connects a rear end of the key body and the fixing part to each other. The connection part has a structure bent so as to protrude upward and contains, on a lower inside of the connection part, a space where the weight on the rear-end side of the hammer is allowed to enter at key-pressing.

Such a configuration can help make the keyboard device compact and also ensure an appropriate key-touch weight. Specifically, in this keyboard device, the connection part that connects the key body and the fixing part to each other has the structure bent so as to protrude upward, and contains, on the lower inside of such a bent structure, the space that the weight on the rear-end side of the hammer can enter at key-pressing. Thus, the weight can be designed to be larger owing to entrance of a part thereof into the space on the lower inside of the bent structure of the connection part. This makes it possible to obtain an appropriate key-pressing load while making the keyboard device compact.

(2) In one aspect of the present disclosure, as the keyboard is viewed in a direction in which the keys are arranged side by side, the space may have a shape reduced in width (i.e., in a dimension in the front-rear direction) toward an upper side.

Such a configuration enables size reduction of an upper part of the space, and thus an upper part of the connection part above the space. This can also help make the keyboard device compact.

(3) In one aspect of the present disclosure, the weight on the rear-end side of the hammer may have a shape protruding toward a pivotal movement side at key-pressing.

Such a shape allows the weight to be accommodated in the space on the lower inside of the connection part when the hammer is pivotally moved. This also makes it possible to reduce the dimension of the space (and thus the connection part) in the front-rear direction as compared with a case in which, for example, the weight protrudes rearward.

(4) In one aspect of the present disclosure, as the keyboard is viewed in a direction in which the keys are arranged side by side, the weight on the rear-end side of the hammer may have a shape reduced in width toward the pivotal movement side at key-pressing.

Such a configuration makes it possible to reduce the range in which the hammer is pivotally moved (i.e., the pivotal movement range). Therefore, the upper part of the space, and thus the upper part of the connection part above the space, can be reduced in size. This can also help make the keyboard device compact.

(5) In one aspect of the present disclosure, on the lower inside of the connection part, a support member may be arranged above a range in which the hammer is pivotally moved at key-pressing, and on an upper surface of the support member, a restrictor that restricts movement of the connection part in a direction in which the keys are arranged side by side may be provided.

With such a configuration, even when the hammer is pivotally moved, the hammer does not come into contact with the support member. Moreover, the movement of the connection part in the left-right direction at key-pressing can be restricted by the restrictor.

### BRIEF DESCRIPTION OF THE DRAWINGS

An example embodiment of the present disclosure will be described below with reference to the accompanying drawings, in which:

FIG. 1 is a side view of a keyboard device as viewed in a direction in which keys are arranged side by side;

FIG. 2A is a perspective view showing a keyboard;

FIG. 2B is an exploded perspective view showing the keyboard in an exploded state;

FIG. 3A is a perspective view of a hammer for a white key;

FIG. 3B is a sectional view of the hammer for the white key taken along a YZ plane;

FIG. 4 is a sectional view showing a structure of the hammer for the white key, taken along a line IV-IV in FIG. 5;

FIG. 5 is a side view showing a configuration of the keyboard device before key-pressing of the white key;

FIG. 6 is a side view showing a configuration of the keyboard device after key-pressing of the white key;

FIG. 7 is a side view showing a connection part of the white key and therearound in an enlarged manner;

FIG. 8 is a perspective view showing a part of a keyboard chassis in a sectioned manner;

FIG. 9 is a sectional view showing a structure of a hammer for a black key, taken along a line IX-IX in FIG. 10;

FIG. 10 is a side view showing a configuration of the keyboard device before key-pressing of the black key;

FIG. 11 is a side view showing a configuration of the keyboard device after key-pressing of the black key; and

FIG. 12 is a side view showing a connection part of the black key and therearound in an enlarged manner.

### DETAILED DESCRIPTION OF EXEMPLARY EMBODIMENTS

### 1. Entire Configuration

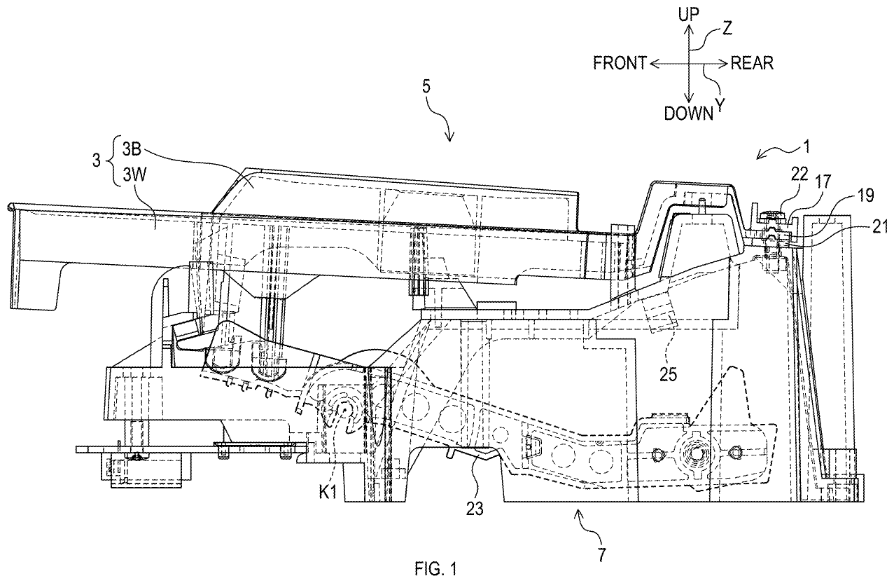

As shown in FIG. 1, a keyboard device 1 of the present embodiment is used as, for example, a keyboard device for a keyboard instrument, such as an electronic piano.

The keyboard device 1 comprises a keyboard 5 and a keyboard chassis 7. The keyboard 5 comprises keys 3. The keys 3 comprise white keys 3W and black keys 3B. Each key of the white keys 3W and the black keys 3B is arranged so as to be pivotally movable. The keyboard chassis 7 supports the keyboard 5.

Hereinafter, a member related to the white key 3W is assigned with a reference numeral including a symbol W, and a member related to the black key 3B is assigned with a reference numeral including a symbol B. However, the symbols W and B are not included in some cases where no distinction is made between the white key 3W and the black key 3B.

In FIG. 1 and other drawings, a front-rear direction corresponds to a Y-axis direction of an XYZ orthogonal coordinate system, an up-down direction (i.e., a vertical direction) corresponds to a Z-axis direction of the same system, and a direction perpendicular to a Y-axis and to a Z-axis (i.e., a left-right direction in which the keys 3 are arranged side by side) corresponds to an X-axis direction of the same system. Each drawing such as FIG. 1 shows the keyboard device 1 in a state placed on a horizontal plane.

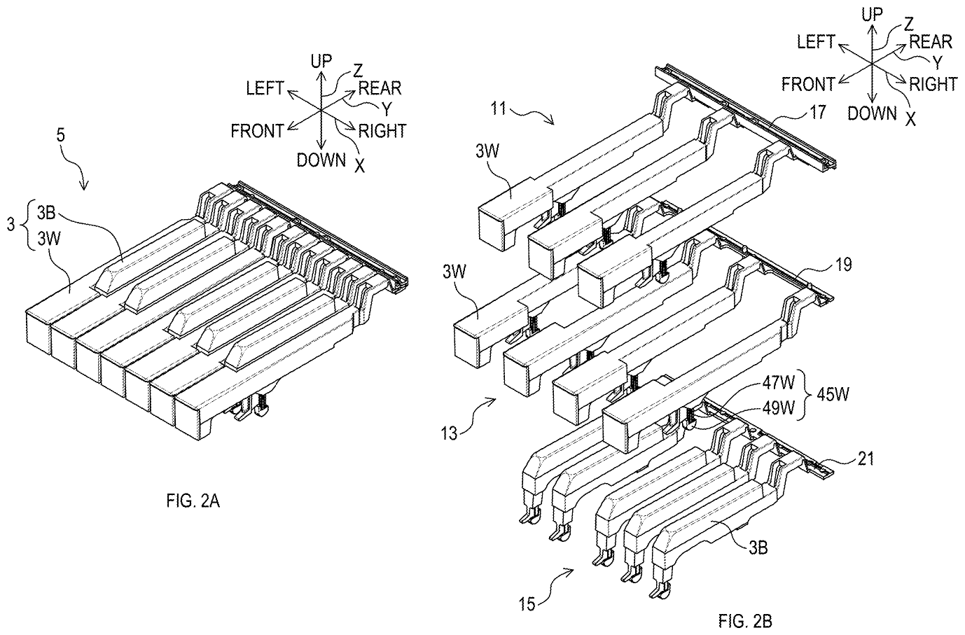

FIG. 2A shows a part of the keyboard 5. As shown in FIG. 2A, the keyboard 5 is configured with the keys 3 (i.e., the white keys 3W and the black keys 3B) arranged in the left-right direction.

As shown in FIG. 2B, the keyboard 5 may be configured by, for example, combining a white-key member 11 with the three white keys 3W integrated therein, another white-key member 13 with the four white keys 3W integrated therein, and a black-key member 15 with the five black keys 3B integrated therein.

The white-key members 11 and 13 and the black-key member 15 are each integrally formed of resin (e.g., ABS resin). The white-key members 11 and 13 are respectively provided with, at respective rear ends thereof, fixing parts 17 and 19 each extending in the left-right direction and having an elongated and substantially plate shape. Rear-end parts of the white keys 3W are integrally connected to the corresponding fixing parts 17 and 19. Similarly, the black-key member 15 is provided with, at a rear end thereof, a fixing part 21 extending in the left-right direction and having an elongated and substantially plate shape. Rear-end parts of the black keys 3B are integrally connected to the fixing part 21.

The fixing parts 17, 19, and 21 are stacked in the up-down direction and integrally fixed to the keyboard chassis 7 with a fixing member, such as a bolt 22 (see FIG. 1).

As shown in FIG. 1, a hammer 23 is arranged under the keyboard 5 for each key 3. The hammer 23 is configured to move pivotally about a pivot point K1 in association with a key-pressing action on the key 3. The keyboard chassis 7 is provided with a stopper 25 arranged above the hammer 23 in order to restrict a pivotal movement of the hammer 23 that goes beyond a specific level at key-pressing. The stopper 25 is formed of, for example, a material having cushioning properties (i.e., a cushioning material), such as felt.

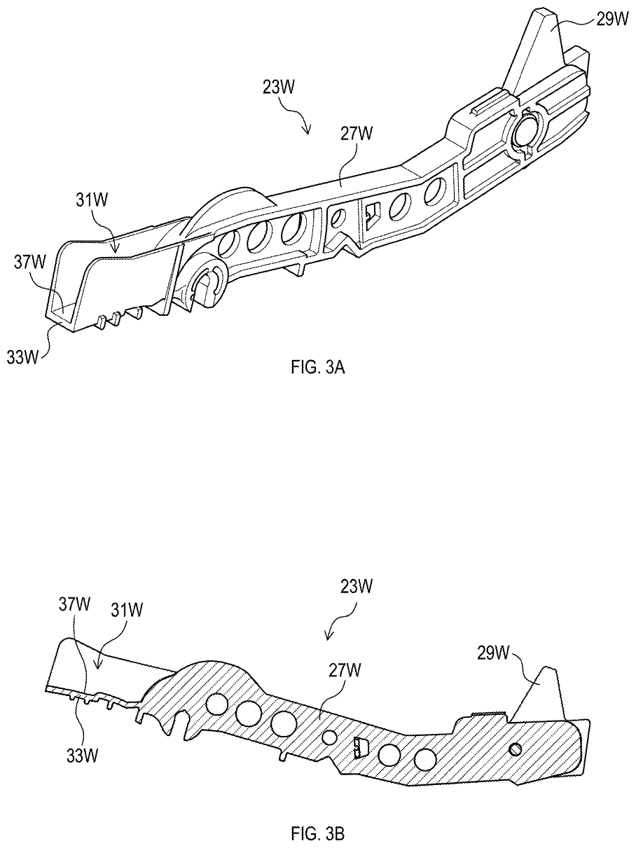

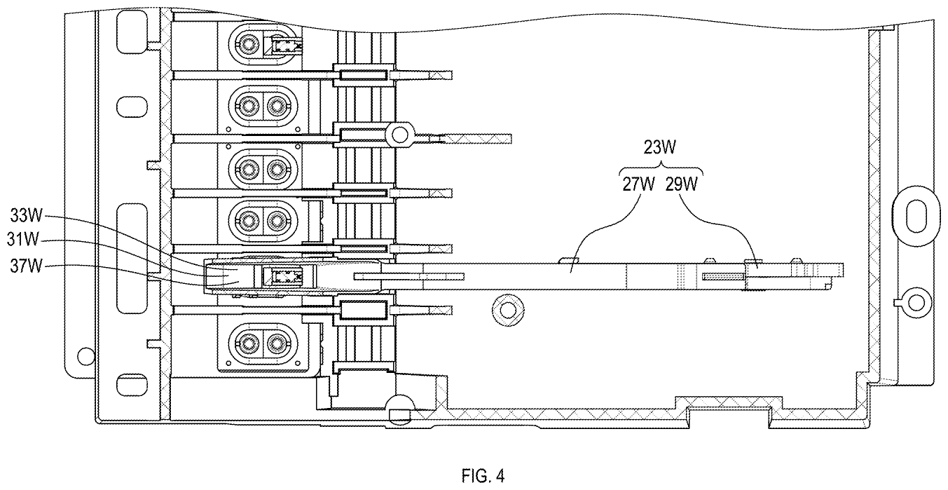

For example as shown in FIGS. 3A, 3B, and 4, a hammer 23W for the white key 3W comprises a hammer body 27W that is made of resin (e.g., polyacetal) and that has an elongated shape, and a weight 29W that is made of metal (e.g., iron) and that is attached to a rear end of the hammer body 27W.

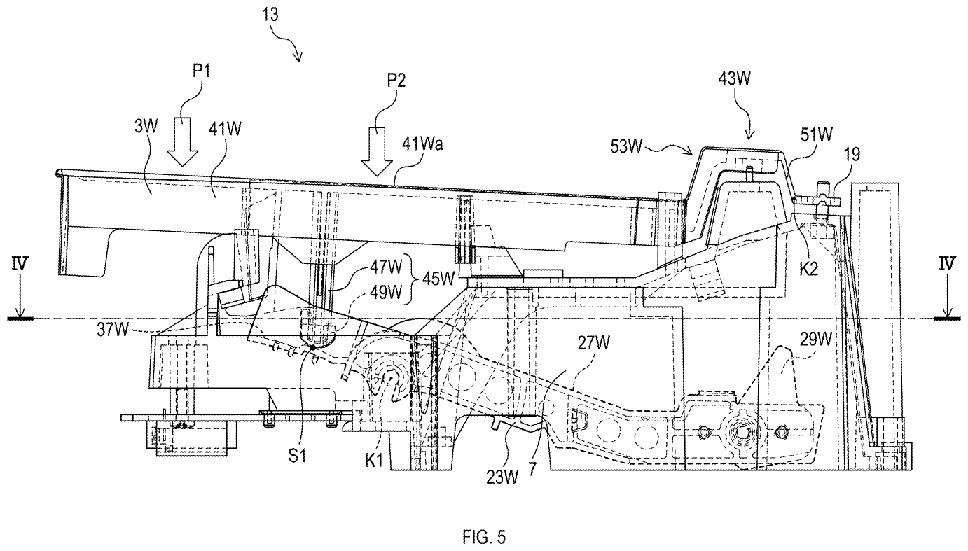

A groove part 31W opened upward and frontward is provided to the hammer 23W on its front-end side. A bottom part 33W of the groove part 31W is provided with a sliding surface 37W as will be described below. The sliding surface 37W is a surface with which an actuator 45W (see, for example, FIG. 5) of the white key 3W contacts and on which it slides. A hammer 23B for the black key 3B has almost the same configuration as will be described below.

As shown in FIG. 5, the weight 29W on a rear-end side of the hammer 23W has a shape protruding toward a pivotal movement side (i.e., in a direction in which the hammer 23W rotates counterclockwise at key-pressing in FIG. 5). Specifically, the weight 29W has a shape reduced in width in a tapered manner toward the pivotal movement side at key-pressing (toward an upper side in FIG. 5), as viewed in the X-axis direction. The pivotal movement side at key-pressing is alternatively described as a side toward which the weight 29W proceeds in association with the pivotal movement of the hammer 23W at key-pressing.

### 2. Elements Related to White Key

Next, elements related to the white key 3W are explained based on FIGS. 5 to 8. For the explanation here, the white-key member 13 is used as an example.

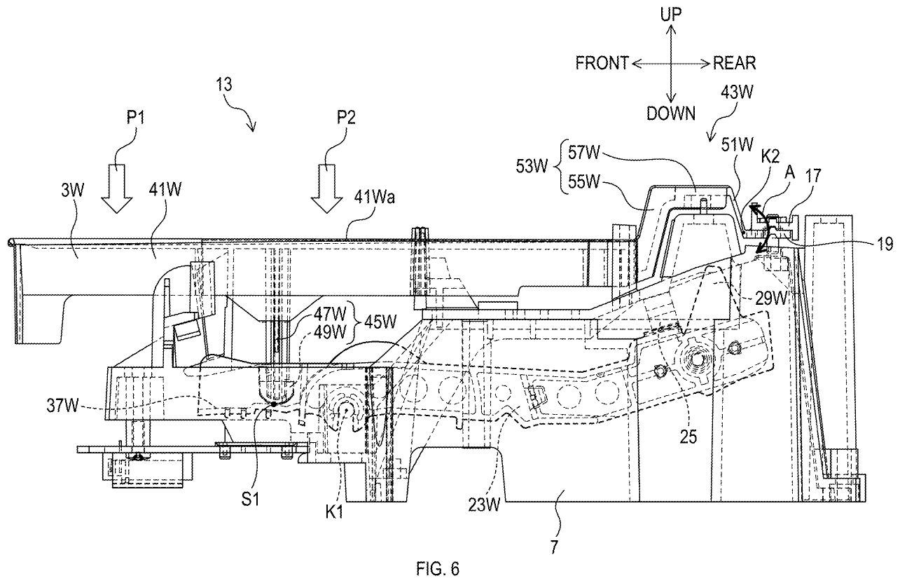

FIG. 5 shows the white key 3W before key-pressing, and thus, the weight 29W on the rear-end side of the hammer 23W is in a lowered state. On the other hand, FIG. 6 shows the white key 3W after key-pressing, and thus, the weight 29W on the rear-end side of the hammer 23W is in a raised state.

As shown in FIGS. 5 and 6, the white key 3W comprises a key body 41W extending in the front-rear direction and having an elongated shape, a fixing part 19 fixed to the keyboard chassis 7, and a connection part 43W that connects a rear end of the key body 41W and a front end of the fixing part 19 to each other. In FIGS. 5 and 6, elements related to the black key 3B are omitted.

On a bottom side of the key body 41W, the actuator 45W is provided so as to protrude downward from the key body 41W perpendicularly to the key body 41W.

The actuator 45W comprises a column body 47W that has a columnar shape and protrudes downward from the key body 41W, and a leading end part 49W that has a substantially hemispherical shape and is attached to a leading end (i.e., a lower end) of the column body 47W.

A hemispherical surface of the leading end part 49W is in contact with the sliding surface 37W of the hammer 23W before key-pressing, and has a function of pressing down a front-end part of the hammer 23W while sliding on the sliding surface 37W in association with a key-pressing action.

As shown in FIG. 6, when the front-end part of the hammer 23W is pressed down, the hammer 23W moves pivotally about the pivot point K1 (i.e., moves pivotally in a counterclockwise direction), whereby a rear-end part (i.e., the weight 29W) of the hammer 23W is raised.

As viewed in the X-axis direction (i.e., as viewed from the side), the connection part 43W has a shape bent so as to protrude upward of a plane containing an upper surface 41Wa of the key body 41W (specifically, a shape bent to be substantially trapezoidal so as to be opened downward). The connection part 43W comprises, on a rear-end side thereof, a hinge part 51W, which is a thin and plate-shaped member with elasticity.

Specifically, as viewed in the X-axis direction, the connection part 43W comprises a connection protrusion 53W having a substantially L-shape on a rear-end side of the key body 41W, and comprises the hinge part 51W on a rear-end side of the connection protrusion 53W. The connection protrusion 53W protrudes upward of the plane containing the upper surface 41Wa of the key body 41W, and a rear end of the connection protrusion 53W and the front end of the fixing part 19 are connected to each other by the hinge part 51W.

More specifically, as shown in FIG. 6, the connection protrusion 53W comprises a protruding part 55W extending upward (specifically, diagonally rearward) from the rear end of the key body 41W, and a parallel part 57W extending rearward from a rear end of the protruding part 55W parallel to the upper surface 41Wa of the key body 41W (i.e., extending in the front-rear direction). Further, an upper end of the hinge part 51W is connected to a rear end of the parallel part 57W. The hinge part 51W extends downward (specifically, diagonally rearward) from the rear end of the parallel part 57W.

The hinge part 51W is a flat-plate-shaped member that is pivotally movable at key-pressing during performance. Specifically, the hinge part 51W is pivotally movable so as to be bent about a key supporting point K2, which is a connection with the fixing part 19, at key-pressing (i.e., at keystroke). The hinge part 51W is rectangular in shape as viewed in a thickness direction (i.e., substantially in the Y-axis direction), and is constant in thickness.

As the keyboard 5 is viewed in a direction in which the keys 3 are arranged side by side (i.e., in the X-axis direction), the key body 41W and the connection protrusion 53W are greater in thickness than the hinge part 51W. In other words, the hinge part 51W is smaller in thickness than the key body 41W and the connection protrusion 53W. The hinge part 51W is smaller in thickness than the fixing part 19.

Accordingly, at key-pressing in which the white key 3W is pressed at, for example, a position indicated by an arrow P1, the hinge part 51W is pivotally movable about the connection with the fixing part 19 (i.e., about the key supporting point K2) along directions A (specifically, in the counterclockwise direction in FIG. 6).

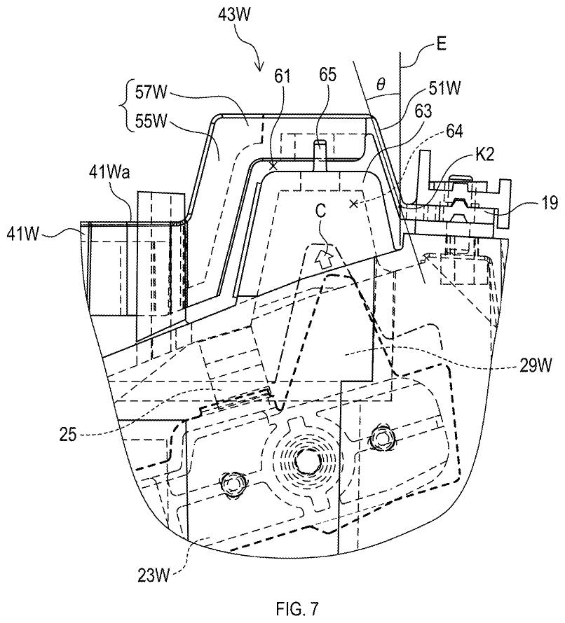

Especially in the present embodiment, as shown in FIG. 7 depicting a part of FIG. 6 in an enlarged manner, the hinge part 51W is provided so as to extend upward (specifically, slightly diagonally forward) from the front end of the fixing part 19, in other words, so as to extend upward of the plane containing the upper surface 41Wa of the key body 41W.

Specifically, as viewed in the X-axis direction, the hinge part 51W is inclined forward by a specific angle (i.e., an inclination angle θ) relative to a vertical line E extending in the Z-axis direction at the key supporting point K2. A value of the inclination angle θ after key-pressing is larger than a value of the inclination angle θ before the key-pressing.

### <Configuration of Connection Part and Therearound>

Here, a characteristic configuration of the connection part 43W and therearound is described.

As shown in FIG. 7, the connection part 43W has a structure bent so as to protrude upward as described above. Specifically, the connection part 43W has a configuration in which the protruding part 55W extends diagonally downward and frontward from a front end of the parallel part 57W and in which the hinge part 51W extends diagonally downward and rearward from the rear end of the parallel part 57W, which configuration is like a trapezoid with a pair of left and right legs more spaced apart from each other toward a lower side.

Accordingly, on a lower inside of the connection part 43W, a space 61 having a substantially trapezoidal shape is arranged as viewed in the X-axis direction.

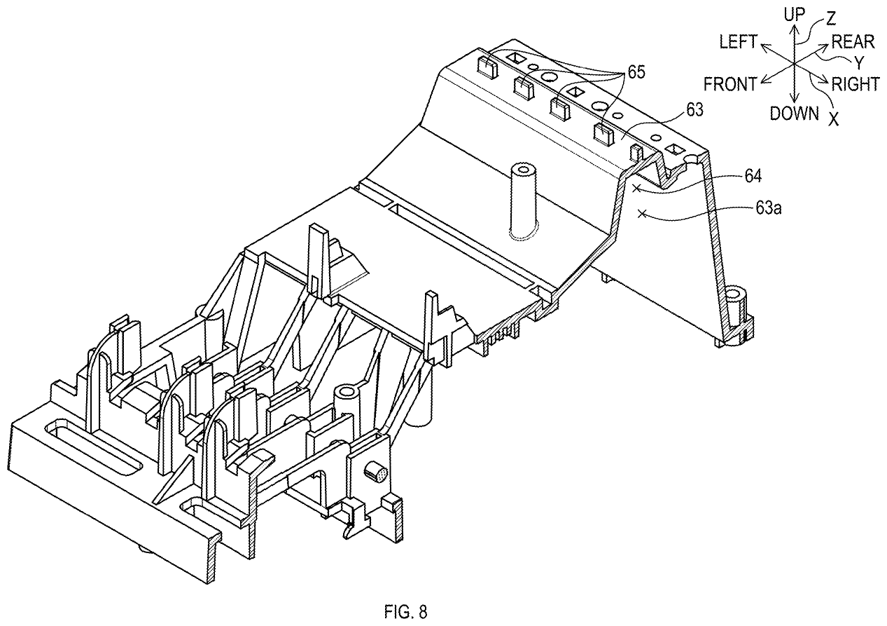

In the space 61, an inner support 63 having a substantially trapezoidal plate shape is arranged along a lower inner surface of the connection part 43W, and as shown in FIG. 8, the inner support 63 is an elongated support member opened downward and extending in the X-axis direction.

Specifically, a width of an opening 63a of the inner support 63 is larger toward a lower side as viewed in the X-axis direction similarly to the above-described connection part 43W, and the inner support 63 has a structure bent to protrude upward to have an arch-like shape with an upper base of a trapezoid and left and right legs.

As shown in FIG. 7, when the white key 3W is pressed, the connection part 43W moves downward, but the position of the inner support 63 is not changed. Thus, a gap large enough to avoid contact between the connection part 43W and the inner support 63 at key-pressing is pressed is arranged between a lower side of the connection part 43W and an upper side of the inner support 63.

On an upper surface of the inner support 63, restrictors 65 that protrude upward so as to each reach the corresponding parallel part 57W are provided for the respective keys 3 along the X-axis direction. Each restrictor 65 comes into contact with the corresponding parallel part 57W when a force is applied in the left-right direction at key-pressing to restrict movement of the parallel part 57W in the left-right direction, thereby inhibiting damage to the corresponding hinge part 51W. The number of the restrictors 65 to be provided may be one.

As shown in FIG. 7, further arranged on a lower inside of the inner support 63 is a lower space 64 having a substantially trapezoidal shape as viewed in the X-axis direction similarly to the above-described space 61.

The lower space 64 has a shape that allows the weight 29W on the rear-end side of the hammer 23W (specifically, a leading end part of the weight 29W on the pivotal movement side) to enter the lower space 64 at key-pressing.

Specifically, a lower surface of the inner support 63 is arranged above a range in which the hammer 23W is pivotally moved at key-pressing (i.e., above a pivotal movement range), and thus, even when the hammer 23W is pivotally moved, the hammer 23W (specifically, the weight 29W) does not come into contact with the inner support 63.

Especially, when the white key 3W is pressed with a strong force, the hammer 23W is pivotally moved at a fast speed accordingly, and thus, when the hammer 23W hits the stopper 25 having cushioning properties, the stopper 25 is deformed and depressed. In such a case, as shown by a dot-and-dash line in FIG. 7, the weight 29W is significantly raised in a direction of arrow C to enter the lower space 64 deeply. In other words, the weight 29W enters the lower space 64 so as to further approach the parallel part 57W.

In the present embodiment, the lower space 64 is designed with sufficient room so that the weight 29W does not come into contact with the inner support 63 even in the case where the weight 29W enters the lower space 64 deeply as described above.

### <Action of White Key>

Next, entire action of the white key 3W is described based on FIGS. 5 to 7.

As shown in FIG. 5, in a state before key-pressing of the white key 3W, the leading end part 49W of the actuator 45W is in contact with the sliding surface 37W of the hammer 23W.

In this state, for example when a front-side part of the white key 3W is pressed at a position indicated by the arrow P1 and/or a position indicated by an arrow P2 (i.e., when key-pressing is started), a force pressing the white key 3W presses the sliding surface 37W on a front-end side of the hammer 23W via the actuator 45W. This causes the hammer 23W to move pivotally about the pivot point K1, whereby the rear-end part of the hammer 23W is raised.

The position indicated by the arrow P1 corresponds to a position forward of a position where the actuator 45W is provided, and the position indicated by the arrow P2 corresponds to a position rearward of the position where the actuator 45W is provided.

Then, as shown in FIG. 6, when the white key 3W is pressed to its lower limit, the sliding surface 37W of the hammer 23W is pressed down to its lower limit by the actuator 45W. In this case, the rear-end part of the hammer 23W is raised to hit the stopper 25, and a further raise is restricted.

As described above (see, for example, FIG. 7), when the white key 3W is pressed with a strong force, the hammer 23W is pivotally moved at a fast speed accordingly, and thus, when the hammer 23W hits the stopper 25, the stopper 25 is deformed and depressed. In such a case, as shown by a dot-and-dash line in FIG. 7, the weight 29W is significantly raised in the direction of arrow C, but since the lower space 64 is designed to be large enough, the weight 29W enters the lower space 64 deeply without coming into contact with the inner support 63.

### 3. Elements Related to Black Key

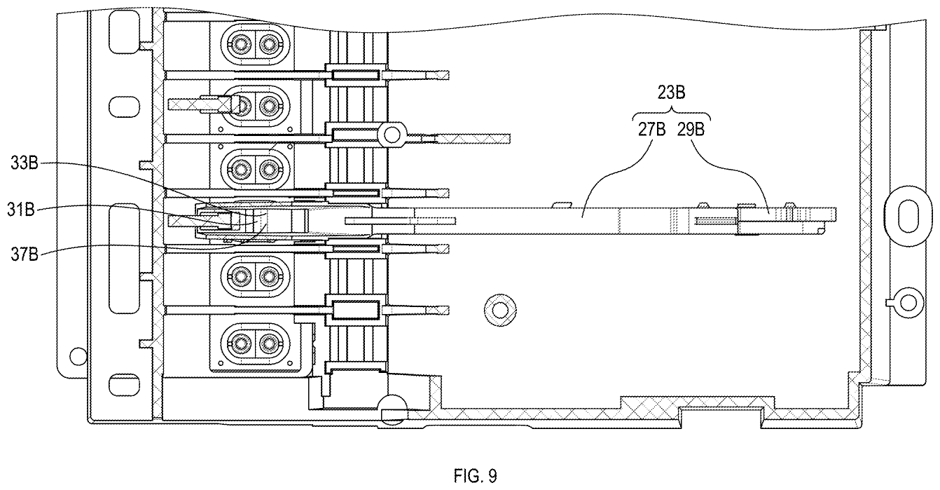

Next, the elements related to the black key 3B are explained based on FIGS. 9 to 12. For the elements similar to those related to the white key 3W, explanation is omitted or simplified.

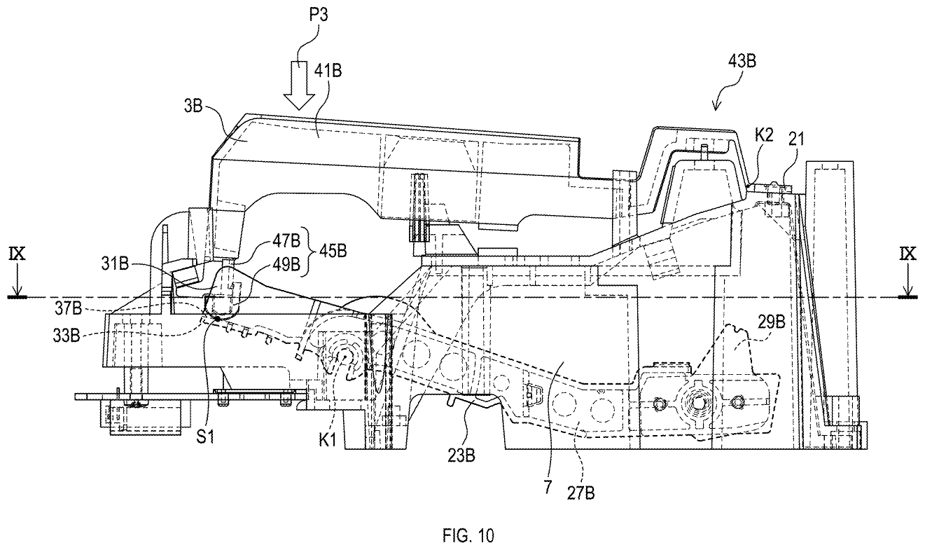

For each black key 3B, the corresponding hammer 23B is arranged. As shown in FIGS. 9 and 10, each hammer 23B comprises a hammer body 27B and a weight 29B in a similar manner as in the hammer 23W of the white key 3W.

The hammer body 27B basically has a shape substantially similar to that of the hammer body 27W, and comprises, on a front-end side of the hammer body 27B, a groove part 31B, a bottom part 33B, and a sliding surface 37B each having the same shape as that of, respectively, the groove part 31W, the bottom part 33W, and the sliding surface 37W of the hammer body 27W. The sliding surface 37B is a sliding surface on which a leading end part 49B of an actuator 45B slides.

As shown in FIG. 10, a shape of the weight 29B is slightly different from that of the weight 29W, and the height of the weight 29B at its upper end is set to be smaller than that of the weight 29W at its upper end.

Similarly to the weight 29W, the weight 29B has a shape protruding toward a pivotal movement side (i.e., in a direction in which the hammer 23B rotates counterclockwise at key-pressing in FIG. 10). Specifically, the weight 29B has a shape reduced in width in a tapered manner toward the pivotal movement side at key-pressing (toward a leading end side), as viewed in the X-axis direction.

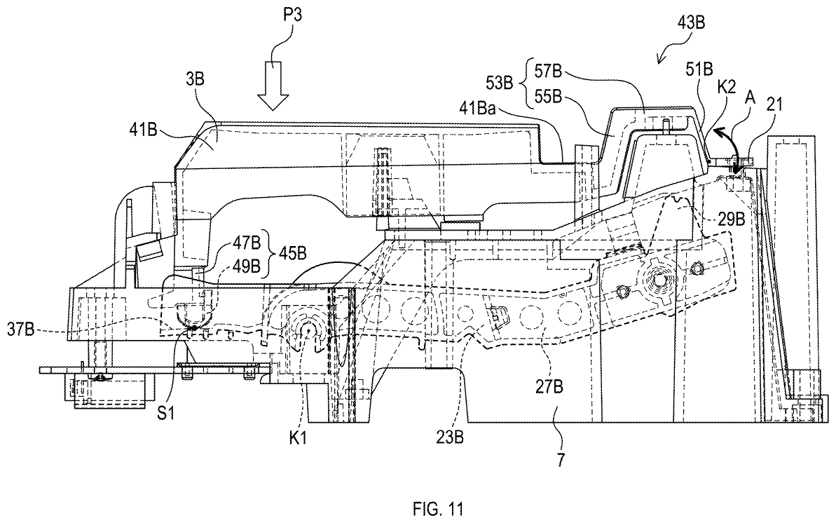

The black key 3B comprises a key body 41B extending in the front-rear direction, the fixing part 21 fixed to the keyboard chassis 7, and a connection part 43B that connects a rear end of the key body 41B and a front end of the fixing part 21 to each other. In FIGS. 10 and 11, the elements related to the white key 3W are omitted.

On a bottom side of a front-end part of the key body 41B, the actuator 45B is provided so as to protrude downward from the key body 41B perpendicularly to the key body 41B.

The actuator 45B comprises a column body 47B that has a columnar shape and protrudes from the key body 41B, and the leading end part 49B that has a substantially hemispherical shape and is attached to a leading end (i.e., a lower end) of the column body 47B.

The leading end part 49B is in contact with the sliding surface 37B of the hammer 23B before key-pressing, and has a function of pressing down a front-end part of the hammer 23B while sliding on the sliding surface 37B in association with a key-pressing action.

Then, as shown in FIG. 11, when the black key 3B is pressed down at a position indicated by an arrow P3, the hammer 23B moves pivotally about the pivot point K1, whereby a rear-end part (i.e., the weight 29B) of the hammer 23B is raised.

In a similar manner as in the white key 3W, the connection part 43B has a shape bent so as to protrude upward. Specifically, the connection part 43B has a similar shape as that of the connection part 43W of the white key 3W as viewed in the X-axis direction, and protrudes upward of an upper surface 41Ba adjacent to the connection part 43B.

The connection part 43B comprises, on a rear-end side thereof, a hinge part 51B, which is a thin and plate-shaped member with elasticity. The hinge part 51B is a rectangular flat-plate-shaped member that is pivotally movable about the key supporting point K2 at key-pressing during performance, as in the white key 3W. The thickness of the hinge part 51B is constant.

Specifically, as viewed in the X-axis direction, the connection part 43B comprises a connection protrusion 53B having a substantially L-shape extending to protrude upward from the rear end of the key body 41B, and the hinge part 51B connects a rear end of the connection protrusion 53B and a front end of the fixing part 21 to each other.

More specifically, the connection protrusion 53B comprises a protruding part 55B extending upward (specifically, diagonally rearward) from the rear end of the key body 41B, and a parallel part 57B extending rearward from a rear end of the protruding part 55B parallel in the front-rear direction. Further, an upper end of the hinge part 51B is connected to a rear end of the parallel part 57B, and the hinge part 51B extends downward (specifically, diagonally rearward) from the rear end of the parallel part 57B.

As the keyboard 5 is viewed in the X-axis direction, the key body 41B and the connection protrusion 53B are greater in thickness than the hinge part 51B. In other words, the hinge part 51B is smaller in thickness than the key body 41B and the connection protrusion 53B. Also, the thickness of the hinge part 51B is smaller than that of the fixing part 21.

Accordingly, when the black key 3B is pressed at, for example, the position indicated by the arrow P3, the hinge part 51B is pivotally movable about the connection with the fixing part 21 (i.e., about the key supporting point K2) along the directions A (specifically, in the counterclockwise direction in FIG. 11).

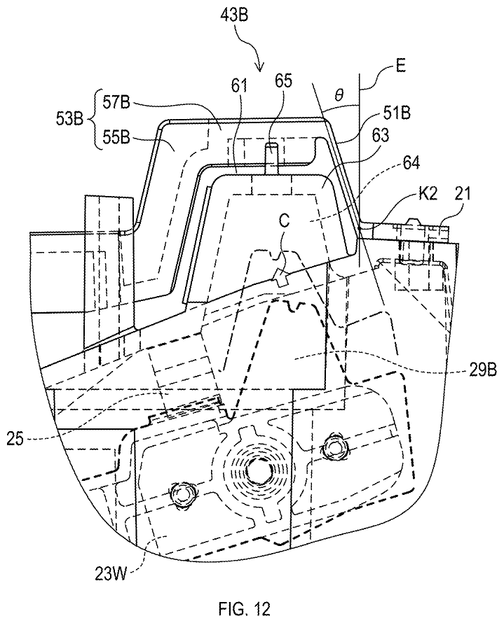

Especially in the present embodiment, as shown in FIG. 12 depicting a part of FIG. 11 in an enlarged manner, the hinge part 51B is provided so as to extend upward (specifically, slightly diagonally frontward) from the front end of the fixing part 21 in a similar manner as in the hinge part 51W of the white key 3W.

Specifically, as viewed in the X-axis direction, the hinge part 51B is inclined forward by a specific angle (i.e., an inclination angle θ) relative to the vertical line E extending in the Z-axis direction at the key supporting point K2. A value of the inclination angle θ after key-pressing is larger than a value of the inclination angle θ before the key-pressing.

### <Configuration of Connection Part and Therearound>

Here, an explanation is given of a characteristic configuration of the connection part 43B and therearound, which is basically similar to that of the connection part 43W and therearound of the white key 3W.

The connection part 43B has a structure bent so as to protrude upward as described above (i.e., in a manner similar to that of the connection part 43W of the white key 3W). That is, the connection part 43B has a shape like a trapezoid with a pair of left and right legs more spaced apart from each other toward a lower side.

Accordingly, on a lower inside of the connection part 43B, the space 61 having a substantially trapezoidal shape is arranged as viewed in the X-axis direction.

In the space 61, the inner support 63 having a substantially trapezoidal shape extending in the X-axis direction is arranged along a lower inner surface of the connection part 43B. Provided on the upper surface of the inner support 63 are the restrictors 65 that protrude upward so as to each reach the corresponding parallel part 57B.

In a similar manner as in the white key 3W, a gap between a lower side of the connection part 43B and an upper side of the inner support 63 is dimensioned to be large enough to avoid contact between the connection part 43B and the inner support 63 at key-pressing.

Further arranged on the lower inside of the inner support 63 is the lower space 64 having a substantially trapezoidal shape as viewed in the X-axis direction as described above, and the lower space 64 has a shape that allows a leading end part of the weight 29B on the rear-end side of the hammer 23B to enter the lower space 64 at key-pressing.

Specifically, in a similar manner as in the white key 3W, the lower surface of the inner support 63 is arranged above the pivotal movement range of the hammer 23B at key-pressing, and thus, even when the hammer 23B is pivotally moved, the hammer 23B does not come into contact with the inner support 63.

Especially, when the black key 3B is pressed with a strong force, the hammer 23B is pivotally moved at a fast speed accordingly, and thus, when the hammer 23B hits the stopper 25, the stopper 25 is deformed and depressed. In such a case, as shown by a dot-and-dash line in FIG. 12, the weight 29B is significantly raised in a direction of arrow C to enter the lower space 64 deeply.

In the present embodiment, the lower space 64 is designed with sufficient room so that the weight 29B does not come into contact with the inner support 63 even in the case where the weight 29B enters the lower space 64 deeply as described above.

### <Action of Black Key>

Next, entire action of the black key 3B is described based on FIGS. 10 to 12.

As shown in FIG. 10, in a state before key-pressing of the black key 3B, the leading end part 49B of the actuator 45B is in contact with the sliding surface 37B of the hammer 23B.

In this state, for example when the black key 3B is pressed at the position indicated by the arrow P3 (i.e., when key-pressing is started), a force pressing the black key 3B presses the sliding surface 37B on the front-end side of the hammer 23B via the actuator 45B. This causes the hammer 23B to move pivotally about the pivot point K1, whereby the rear-end part of the hammer 23B is raised.

Then, as shown in FIG. 11, when the black key 3B is pressed to its lower limit, the sliding surface 37B of the hammer 23B is pressed down to its lower limit by the actuator 45B. Thus, the rear-end part of the hammer 23B is raised to hit the stopper 25, and a further raise is restricted.

As described above (see, for example, FIG. 12), when the black key 3B is pressed with a strong force, the hammer 23B is pivotally moved at a fast speed accordingly, and thus, when the hammer 23B hits the stopper 25, the stopper 25 is deformed and depressed. In such a case, the weight 29B is significantly raised in the direction of arrow C, but since the lower space 64 is designed to be large enough, the weight 29B enters the lower space 64 deeply without coming into contact with the inner support 63.

### 4. Effects

The embodiment detailed above produces effects described below. The symbols W and B are omitted below.

(4a) In the keyboard device 1 of the present embodiment, the hammer 23 comprises the weight 29 on its rear-end side, and each key 3 comprises the key body 41 extending in the front-rear direction, a corresponding one of the fixing parts 17, 19, and 21 fixed to the keyboard chassis 7, and the connection part 43 that connects the rear end of the key body 41 and the corresponding one of the fixing parts 17, 19, and 21 to each other. The connection part 43 has a structure bent to protrude upward and contains, on the lower inside of such a structure, the space 61 (specifically, the lower space 64) that the weight 29 on the rear-end side of the hammer 23 can enter at key-pressing.

Such a configuration can help make the keyboard device 1 compact and also ensure an appropriate key-touch weight. Specifically, the connection part 43 of the keyboard device 1 has the structure bent so as to protrude upward, and contains, on the lower inside of such a bent structure (specifically, on the lower inside of the inner support 63), the lower space 64 that the weight 29 of the hammer 23 can enter at key-pressing. Thus, the weight 29 can be designed to be larger owing to entrance of a part thereof into the lower space 64 on the lower inside of the bent structure of the connection part 43. This makes it possible to obtain an appropriate key-pressing load while making the keyboard device 1 compact.

(4b) In the present embodiment, as the keyboard 5 is viewed in the direction in which the keys 3 are arranged side by side (i.e., in the left-right direction), the space 61 (specifically, the lower space 64) has a shape reduced in width (i.e., in the dimension in the front-rear direction) toward an upper side.

Such a configuration enables size reduction of an upper part of the space 61, and thus an upper part of the connection part 43 above the space 61. This can also help make the keyboard device 1 compact.

(4c) In the present embodiment, the weight 29 on the rear-end side of the hammer 23 has a shape protruding toward the pivotal movement side at key-pressing.

Such a configuration allows the weight 29 to be accommodated in the space 61 (specifically, the lower space 64) on the lower inside of the connection part 43 when the hammer 23 is pivotally moved. This also makes it possible to reduce the dimension of the space 61 (in other words, the connection part 43) in the front-rear direction as compared with a case in which, for example, the weight 29 protrudes rearward.

(4d) In the present embodiment, as the keyboard 5 is viewed in the left-right direction, the weight 29 of the hammer 23 has a shape reduced in width toward the pivotal movement side at key-pressing.

Such a configuration makes it possible to reduce the range in which the hammer 23 is pivotally moved (i.e., the pivotal movement range). Therefore, the upper part of the space 61, and thus the upper part of the connection part 43 above the space 61, can be reduced in size. This can also help make the keyboard device 1 compact.

(4e) In the present embodiment, on the lower inside of the upwardly-bent structure of the connection part 43, the inner support 63 is arranged above the pivotal movement range of the hammer 23 at key-pressing, and on the upper surface of the inner support 63, the restrictors 65 each restricting movement of the corresponding connection part 43 in the left-right direction are provided.

With such a configuration, even when the hammer 23 is pivotally moved, the hammer 23 does not come into contact with the inner support 63. Moreover, since the movement of the connection part 43 in the left-right direction at key-pressing can be restricted by the restrictor 65, damage to the thin hinge part 51 can be inhibited.

### 5. Other Embodiments

Although the embodiment of the present disclosure has been described so far, the present disclosure may take various forms without being limited to the above-described embodiment.

(5a) For example, the shape of the connection part (as viewed in the X-axis direction) is not limited to the substantially trapezoidal shape, and may be various shapes, such as a shape curved so as to protrude upward.

(5b) As the shape of the weight, other than the shape in which the width on the leading end side is reduced in a tapered manner, various shapes may be employed. For example, a circular shape, a polygonal shape, and other shapes may be employed.

(5c) A function of a single element in the above-described embodiments may be performed by two or more elements in a distributed manner, and a function of two or more elements may be performed by a single element in an integrated manner. A part of the configuration in the above-described embodiments may be omitted. At least a part of the configuration in the above-described embodiments may be added to or replace a configuration in other embodiments.

What is claimed is:

1. A keyboard device comprising:
a keyboard in which keys are provided so as to be each pivotally movable;
a hammer configured to be pivotally moved by being pressed by each key at key-pressing; and
a keyboard chassis that supports the keyboard and the hammer,
the hammer including a weight on its rear-end side,
each key including:
a key body extending in a front-rear direction;
a fixing part fixed to the keyboard chassis; and
a connection part that connects a rear end of the key body and the fixing part to each other, and
the connection part having a structure bent so as to protrude upward and containing, on a lower inside of the connection part, a space where the weight on the rear-end side of the hammer is allowed to enter at key-pressing.

2. The keyboard device according to claim 1,
wherein, as the keyboard is viewed in a direction in which the keys are arranged side by side, the space has a shape reduced in width toward an upper side.

3. The keyboard device according to claim 1,
wherein the weight on the rear-end side of the hammer has a shape protruding toward a pivotal movement side at key-pressing.

4. The keyboard device according to claim 2,
wherein the weight on the rear-end side of the hammer has a shape protruding toward a pivotal movement side at key-pressing.

5. The keyboard device according to claim 3,
wherein, as the keyboard is viewed in a direction in which the keys are arranged side by side, the weight on the rear-end side of the hammer has a shape reduced in width toward the pivotal movement side at key-pressing.

6. The keyboard device according to claim 4,
wherein, as the keyboard is viewed in a direction in which the keys are arranged side by side, the weight on the rear-end side of the hammer has a shape reduced in width toward the pivotal movement side at key-pressing.

7. The keyboard device according to claim 1,
wherein, on the lower inside of the connection part, a support member is arranged above a range in which the hammer is pivotally moved at key-pressing, and on an upper surface of the support member, a restrictor that restricts movement of the connection part in a direction in which the keys are arranged side by side is provided.

8. The keyboard device according to claim 2,
wherein, on the lower inside of the connection part, a support member is arranged above a range in which the hammer is pivotally moved at key-pressing, and on an upper surface of the support member, a restrictor that restricts movement of the connection part in a direction in which the keys are arranged side by side is provided.

9. The keyboard device according to claim 3,
wherein, on the lower inside of the connection part, a support member is arranged above a range in which the hammer is pivotally moved at key-pressing, and on an upper surface of the support member, a restrictor that restricts movement of the connection part in a direction in which the keys are arranged side by side is provided.

10. The keyboard device according to claim 4,
wherein, on the lower inside of the connection part, a support member is arranged above a range in which the hammer is pivotally moved at key-pressing, and on an upper surface of the support member, a restrictor that restricts movement of the connection part in a direction in which the keys are arranged side by side is provided.

11. The keyboard device according to claim 5,
wherein, on the lower inside of the connection part, a support member is arranged above a range in which the hammer is pivotally moved at key-pressing, and on an upper surface of the support member, a restrictor that restricts movement of the connection part in a direction in which the keys are arranged side by side is provided.

12. The keyboard device according to claim 6,
wherein, on the lower inside of the connection part, a support member is arranged above a range in which the hammer is pivotally moved at key-pressing, and on an upper surface of the support member, a restrictor that restricts movement of the connection part in a direction in which the keys are arranged side by side is provided.
